(19) United States
(12) Patent Application Publication
(10) Pub. No.: US 2009/0064573 A1
(43) Pub. Date: Mar. 12, 2009

(54) Flower planter for railings and fences

(76) Inventor: John Braun, Baltimore, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/900,509

(22) Filed: Sep. 12, 2007

(51) Int. Cl. A01G 9/02

(52) U.S. Cl. 47/65.5

(57) ABSTRACT

The planter receptacle is for use on a railing of a balcony, deck, porch, or patio, or for use on a fence, or the surface of a balcony/deck/porch instead. The planter receptacle is made to securely rest on the railing top, straddle a railing when using two planter receptacles, hang down the side of a railing, or be used in combinations of such installations at the same location of the railing for more elaborate planter arrays. No tools or hardware, except a flexible line such as a length of rope, are required to secure the planter receptacle to the railing or fence. When the planter receptacle is used in a hanging position, it can be readily adjusted for leveling and/or to accommodate the vertical height of flowers as they may quickly grow, thereby improving their viewing from both sides of the railing throughout the season. The planter receptacle can be constructed and finished to coordinate in appearance with the railing or fence, or the structure to which the railing is attached, if preferred.

### BACKGROUND OF THE INVENTION

1. Field of the Invention

Generally, this invention relates to receptacles for holding flowers and plants. In particular, the present invention relates to a versatile flower planter configured for use on a deck or porch railing or fence in any of a wide variety of positions. This flower planter may also be used separately from a railing or fence.

2. Background of the Art

Flowers and plants are often used to improve local area aesthetics, and improve the attractiveness and appeal of a home or yard. In appropriate climates, outdoor flowers and plants in particular are lent to flourishing and beautifying a surrounding area. With the popularity of flowering plants for decorative and landscaping purposes, people often use potted flowers on outside decks, porches, and patios, including railings or fencing that often borders their perimeter.

In urban and suburban settings, apartments and condominiums often have small porches or balconies that residents use for outdoor relaxation, yet space is typically quite limited. Often, there is little to no space to store guest chairs, grilling equipment, outdoor toys, or other items typically used on porches and balconies. Similarly, there is often little space to place flowerpots or planters. Long narrow flowerpots may be placed adjacent to the porch or balcony railing, or round pots may be placed in corners, in an attempt to minimize the loss of space on the porch surface. However, space limitations can be so severe that any porch or balcony surface placement becomes impractical.

One approach to resolving the space problem is to place flower planters on top of the railing. Unfortunately, not all railings have flat tops that would be suitable for such placement. Further, rail top positioning poses stability issues, particularly given the likelihood of toppling from an elevated position (i.e., the balcony of a condominium), or from an inconvenient position (i.e., the deck of an above ground pool), risking damage to property. Accordingly, fastened mountings for planters on top of, or alongside the top portion of, a railing might be preferred. Some examples are taught in U.S. Pat. Nos. 1,852,650; 4,559,738; 4,698,936; 5,240,214; and 5,269,095. Yet fastening of this type does not provide for beautification along lower portions of railings, and required screws, bolts, or similar fasteners make installation more difficult, and more permanent, and may prove incompatible with certain railing types and designs.

To further overcome the limitations of using planters on balconies, porches, and decks, planter/flowerpot holders are frequently hung from railings with a wire frame structure dimensioned to receive the entirety of the planter or flowerpot, hooking at various points over the top of the railing. For instance, a prior railing hanger engages the upper edge of a railing or fence, and has a substantially vertical leg that extends downwardly along one side of the railing or fence, and supports a flowerpot at a desired height above the ground. The depending leg of the hanger, and the suspended flowerpot, rest against the railing or fence under the weight of the flowerpot and soil contained therein, such as shown in U.S. Pat. Nos. 1,353,853; 1,955,476; and 4,059,248. Another railing hanger used to support a flowerpot or a planter from an upright support, such as a deck railing or a fence, is described in U.S. Pat. No. 5,390,443 to Emalfarb et al., wherein a wire planter hanger suspends a planter in a fixed position from the top of a railing. However, hanger mechanisms that are separate from the planter receptacle typically add considerably to the cost of a suitable installation, and are less secure, particularly when bumped in an upward manner. Hanger type planter installations may also be too abrasive, affecting the smooth painted finish of metal or composite railings or plastic fencing. Further, vertical adjustment capability for hanger type planter installations is typically lacking or limited. Vertical adjustment capability for planters in a hanging position is useful for leveling elongated planters and to accommodate increases in flower height relative to a railing/fence throughout the growing season.

Space limitations are further compounded for serious balcony and porch gardeners who need more expansive planting accommodations, such as provided by multiple planter arrays. Alternatives for multiple planter installations along a given segment of railing or fence are limited. Some examples of a twin planter designed to straddle the top of a railing are taught in DE Patent No. 29912061U1 to Otero and again in FR Patent No. 2839432A1 to Antoine. Although these alternatives afford expansion over railing top planters and one-sided hanger solutions, they do not provide for the use of lower portions of railings, and they are not likely to integrate well, either mechanically or aesthetically, with either railing top planters or one-sided hanger solutions. An example of such integration is taught in U.S. Pat. No. 4,896,456 to Grant. However, the specialized hangers and planter hooking mechanism of Grant are lent more to custom installations, especially taking the height of the fence into consideration, and suffer given higher requisite costs to manufacture. Further, the hanger brackets pose the same difficulties concerning railing/fence scuffing and abrasion, and stability if bumped upwardly, as discussed previously.

Furthermore, there is an ever widening selection of railing and fence types in the marketplace today. When considered in relation to the frequency with which people relocate for career or life-style changes, this creates a need for a highly adaptive planter that provides an installation that is transferable as between railing types, including metal, wood, plastic resin, and various composite materials, and as between varying railing styles and designs. Planter installation versatility is essential in order to balance desired outdoor aesthetics across a wide variety of porch and deck railing and fence constructions, while maintaining affordability of outdoor furnishings and equipment overall.

From the foregoing, it is apparent that there is a need for a versatile flower planter receptacle that can be used on either a flat surface, or on a railing or fence, that is secure and stable when installed on a railing or fence, that is affordable and cost effective, easy to install, easy to adjust vertically for planter leveling and to improve viewing and accommodate plant growth throughout the season, that provides for installation with an extensive variety of railing types and designs, and that permits either single or multiple planter installations at the same railing location to create integrated decorative flower planter arrays. Known prior art is lacking in this extensive combination of features.

### SUMMARY OF THE INVENTION

The present invention provides a simply designed, versatile, and affordable planter receptacle that is usable with a variety of horizontal railings and fences, and is usable separately from such railings/fence on any flat surface.

It is an object of the present invention to provide a planter receptacle that is easy to install and use on balcony, porch, and deck railings in order to preserve space. It is a related object of the present invention to provide a planter receptacle that requires no tools or special hardware for installation and use on railings and fencing. It is a further related object of the present invention to provide a planter receptacle that affords a variety of position possibilities.

With regard to one aspect of a particularly preferred embodiment of the invention, the planter receptacle is provided leveling capability, and allows viewing of contained flowers or plants from either side of the railing by providing convenient height adjustment functionality.

With regard to another aspect of a particularly preferred embodiment, the planter receptacle is integrateable mechanically and aesthetically to permit the use of multiple receptacles to create a planter array along a given segment of railing.

The novel planter receptacle described herein can be securely attached to a wide variety of railing types and designs. The planter receptacle is uniquely designed to conveniently install onto a railing top, to hang down the side of a railing, to straddle a railing using 2 planter receptacles, and to provide for combinations of these installation alternatives using multiple receptacles. A high level of utility and versatility is obtained by using a flexible line, such as a length of rope, to lace through a series of tube-like guides and gate-like openings and around spool posts that are incorporated into the design of the planter receptacle. Various installations, even with just a single length of rope, can be achieved using various lacing and tie-on configurations. As installed in a hanging position, the planter receptacle can be adjusted vertically for leveling, and/or to improve viewing, and/or to accommodate flowers and plants that quickly increase in height as the growing season progresses.

The planter receptacle may be made from a variety of materials, including wood, plastic resins, composite materials, or metal, to match existing railing/fencing materials. Moreover, such planter receptacle may be finished to match the railing on which it is installed, or the structure to which the railing is attached. Such a planter receptacle for attachment to a railing/fence can be mass-produced and sold for a reasonable price, and can be installed and used by most any person.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a perspective view of a planter receptacle according to one embodiment of the invention;

FIG. 2 shows a sectional view of the planter receptacle of FIG. 1, along the line 2-2, with a flexible line installed in the planter receptacle;

FIG. 3 shows a sectional view of a planter receptacle according to another embodiment of the invention;

FIG. 4 is a perspective view of a planter receptacle according to yet another embodiment of the invention;

FIG. 5 shows a sectional view of the planter receptacle of FIG. 4, along the line 3-3, with a flexible line installed in the planter receptacle;

FIG. 6 is a bottom, perspective view of the planter receptacle of FIG. 1;

FIG. 7 is a perspective view of the planter receptacle of FIG. 4 with posts installed on a side wall of the planter receptacle;

FIG. 8 is a bottom, perspective view of the planter receptacle of FIG. 1 according to yet another embodiment of the invention;

FIG. 9 is a bottom, perspective view of a planter receptacle according to yet another embodiment of the invention;

FIG. 10 is a perspective view of a planter receptacle according to still yet another embodiment of the invention;

FIG. 11 shows a side view of an installation of multiple planter receptacles (an array) according to one aspect of a particularly preferred embodiment of the invention;

FIG. 12 shows a front view of an installation of an array of planter receptacles according to another aspect of a particularly preferred embodiment of the invention; and

FIGS. 13-18 show various lacing techniques for attaching a planter receptacle according to the invention to a railing or fence.

### DETAILED DESCRIPTION OF THE INVENTION

The invention summarized above and defined by the enumerated claims may be better understood by referring to the following description, which should be read in conjunction with the accompanying drawings in which like reference numbers are used for like parts. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

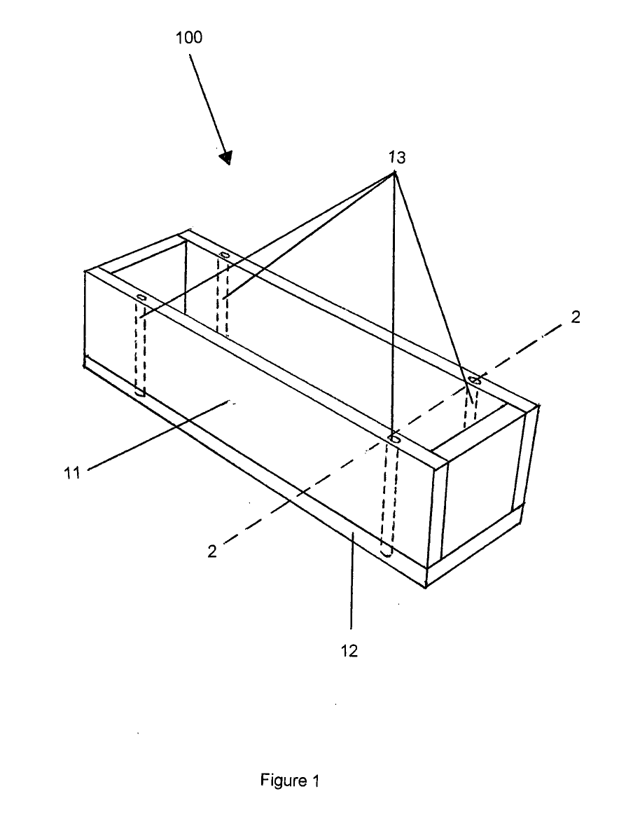

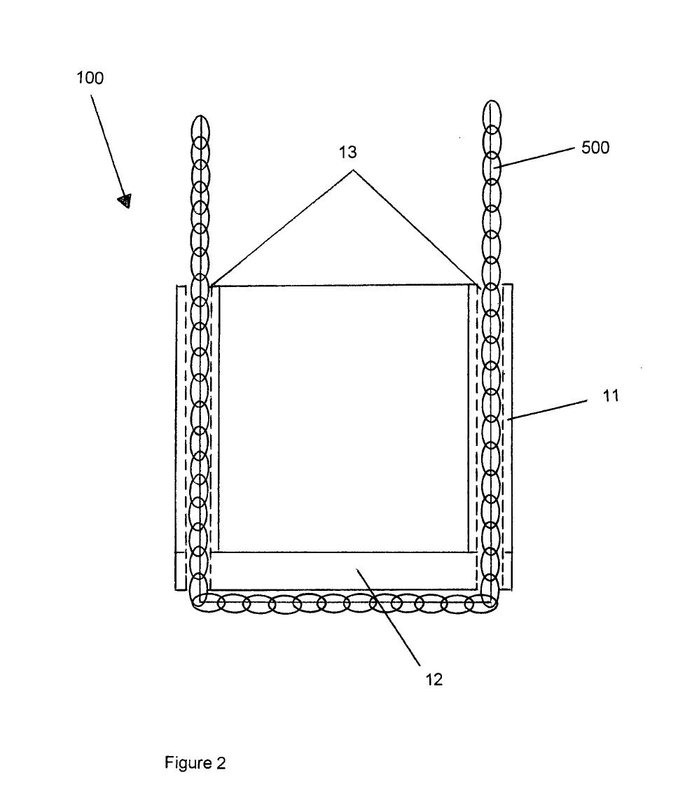

Referring to the drawings, FIG. 1 shows a planter receptacle according to a first embodiment of the present invention, indicated generally at 100. Planter receptacle 100 provides an open enclosure comprising a vertical side wall 11, a horizontal bottom wall 12 (best seen in FIGS. 2 and 6), and a number of guides 13 that enable the positioning of a flexible line, such as a length of rope, along the perimeter of the planter receptacle. While each of the side walls is depicted as being generally aligned in a fully vertical plane, one or more side walls may alternatively be tapered, thus extending generally vertically although not perpendicular to bottom wall 12.

FIG. 2, which depicts a sectional view of the planter receptacle of FIG. 1 along the line 2-2, shows planter receptacle 100 with a flexible line 500 positioned in guides 13. In the embodiment of FIG. 2, flexible line 500 is threaded through guides 13, and across the lower surface of horizontal bottom wall 12, in order to support and stabilize planter receptacle 100 when used in a hanging position on a railing or fence. Rope, cable, chain, or the like, might be used as a suitable flexible line. However, rope might be preferred in order to avoid scuffing or abrasion to the railing or fence.

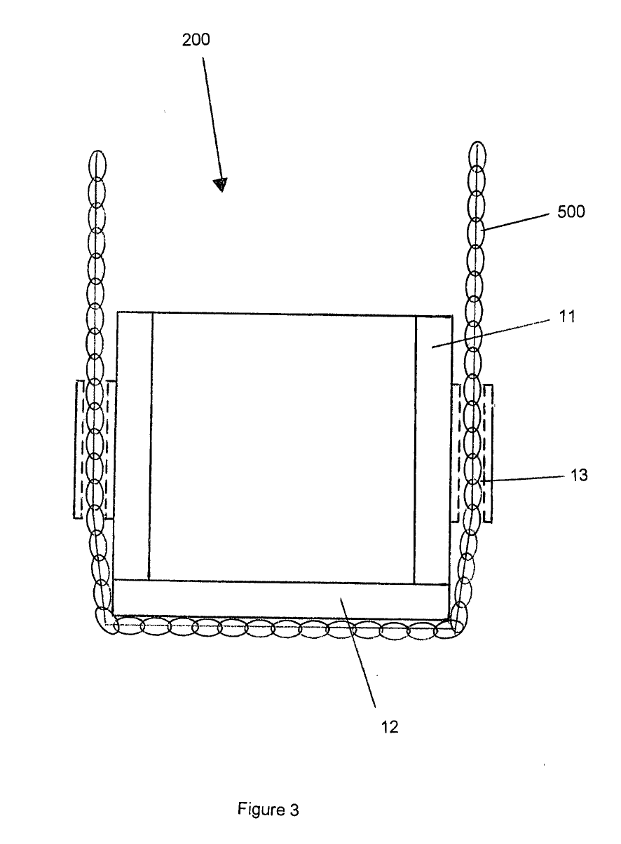

In an alternate embodiment, FIG. 3 shows a side view of a planter receptacle, indicated generally at 200. Planter receptacle 200 has an alternate line guide mechanism. In this embodiment, guides 13 are positioned on the exterior of side wall 11. Again, flexible line 500 is threaded through guides 13, and across the lower surface of horizontal bottom wall 12, in order to support and stabilize the planter receptacle when used in a hanging position on a railing or fence.

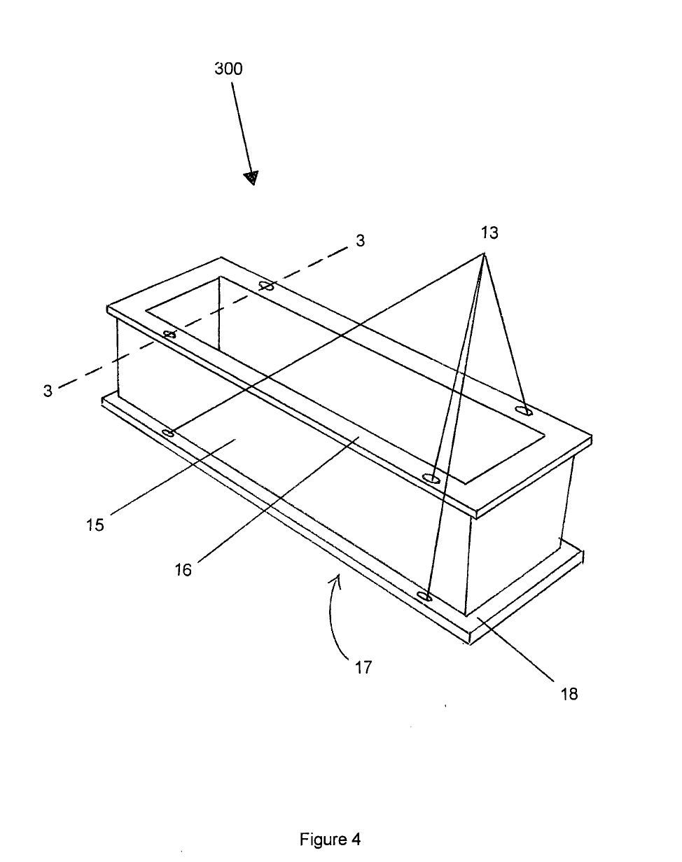

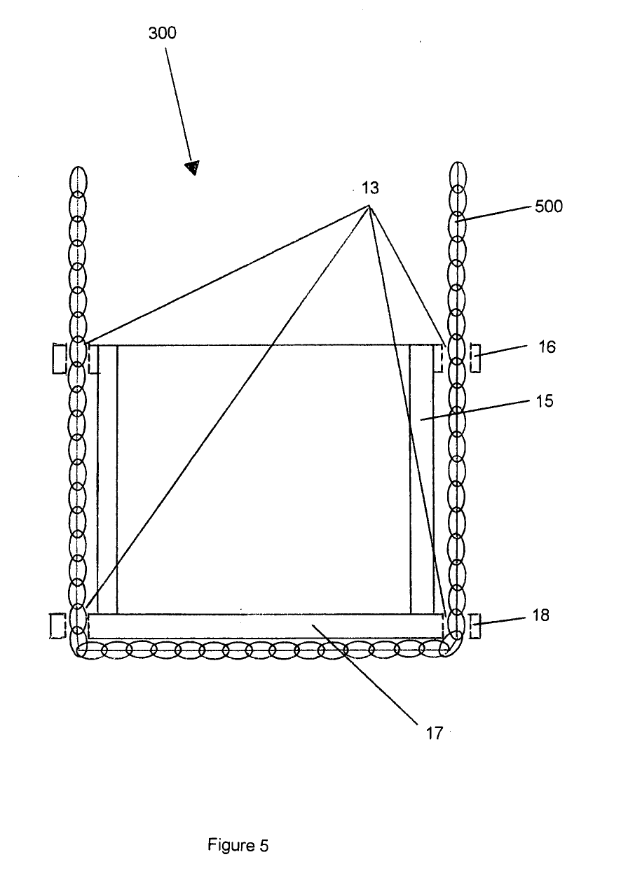

FIG. 4 illustrates an alternate embodiment of the present invention, indicated generally at 300. Planter receptacle 300 forms an open enclosure comprising a vertical side wall 15, an upper ledge 16, and a horizontal bottom wall 17 (best seen in FIG. 5) that protrudes horizontally relative to side wall 15, thereby providing a lower ledge 18. The upper and lower ledges contain a number of guides 13 that enable positioning of a flexible line.

FIG. 5, which depicts a sectional view of the planter receptacle of FIG. 4 along the line 3-3, shows planter receptacle 300 with a flexible line 500. Flexible line 500 is threaded through guides 13 and across the lower surface of horizontal bottom wall 17 in order to support and stabilize planter receptacle 300 when used in a hanging position.

FIG. 6 shows an illustration of the underside of planter receptacle 100. As indicated previously, planter receptacle 100 comprises a horizontal bottom wall 12, a vertical side wall 11, and a number of guides 13 that receive flexible line 500. Planter receptacle 100 further comprises line take-up spool posts 19a and 19b along the lower surface of bottom wall 12. Line 500 on the left side of FIG. 6 is shown not engaging line take-up spool post 19a; line 500 on the right side of FIG. 6 is shown engaging line take-up spool post 19b. Line take-up spool posts afford the utility to quickly and easily create a shortened vertical line when used in an engaged position (restraining the line), or a lengthened vertical line when released from an engaged position (line not restrained). This functionality provides convenient leveling capability and height adjustment capability when the planter is tied to a railing or fence. Multiple posts might be employed to provide a range of height possibilities, or the line might be wrapped around a take-up spool post to provide further variation in its vertical length. Posts of varying diameters might also be used. Alternately, a small slotted partition, or similarly configured structure, might also be used for suitable line restraint in order to achieve the desired functionality.

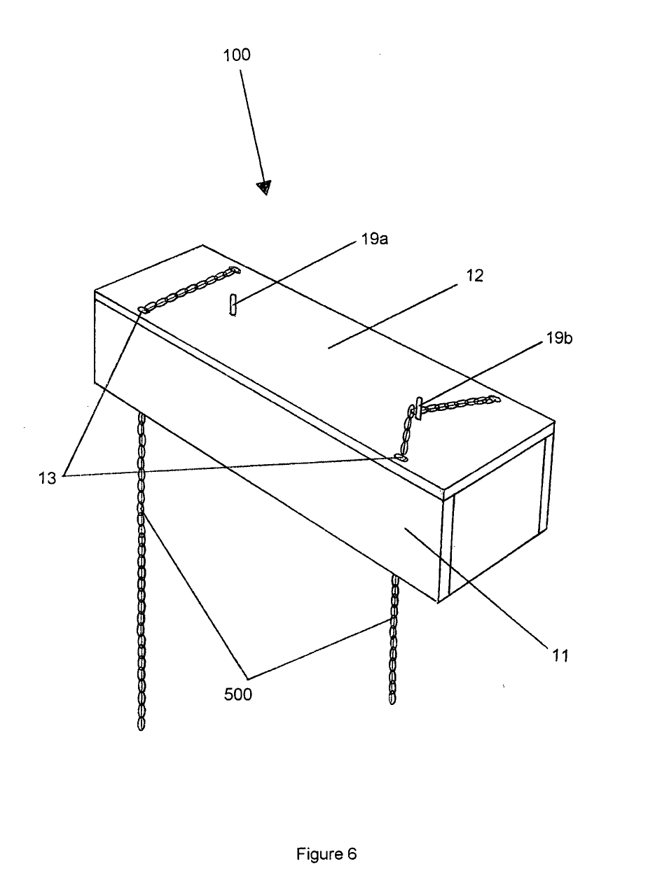

FIG. 7 shows planter receptacle 300 with line take-up spool posts 19c and 19d along the outside of vertical side wall 15. Line 500 on the left side of FIG. 7 is shown not engaging line take-up spool post 19c; line 500 on the right side of FIG. 7 is shown engaging line take-up spool post 19d. As with line take-up spool posts positioned on horizontal bottom wall 12 of FIG. 6, line take-up spool posts 19c and 19d on vertical side wall 15 likewise allow quick and easy shortening of line 500 when used in an engaged position, or lengthening of line 500 when released from an engaged position, so as to allow convenient leveling and height adjustment of planter 300. Optionally, line take-up spool posts may be provided on both a bottom wall and one or more side walls of planter 100. Moreover, any number of take-up spools may be provided on such walls in varied configurations to maximize the extent to which vertical adjustments of the planter receptacle may be made.

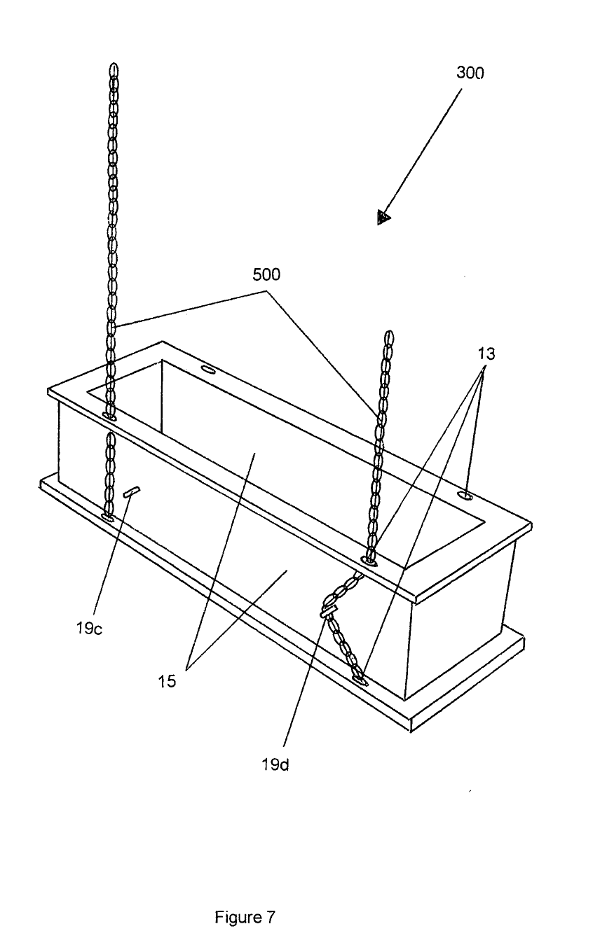

FIG. 8 again shows an underside view of planter receptacle 100 with additional enhancements. In particular, supportive lip 20 (which may be integrally formed with planter receptacle 100 or separately attached) is shown along the perimeter of the lower surface of horizontal bottom wall 12. Further, gate-like openings 21 are shown in supportive lip 20. A supportive lip permits the planter receptacle to be more stable on a flat surface, despite lower surface features, such as line take-up spool posts 19. Alternately, using multiple appropriately configured spool posts along the lower surface of a receptacle bottom wall may also provide stability for planter installations on a flat surface. Gate-like openings in the supportive lip 20 provide for line 500 to pass through to especially accommodate railing top installations of the planter.

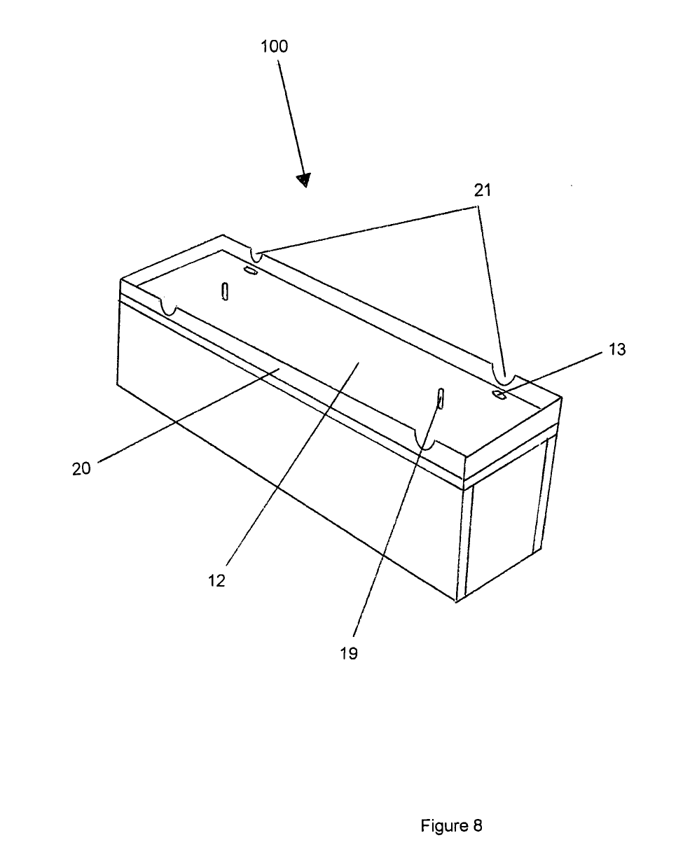

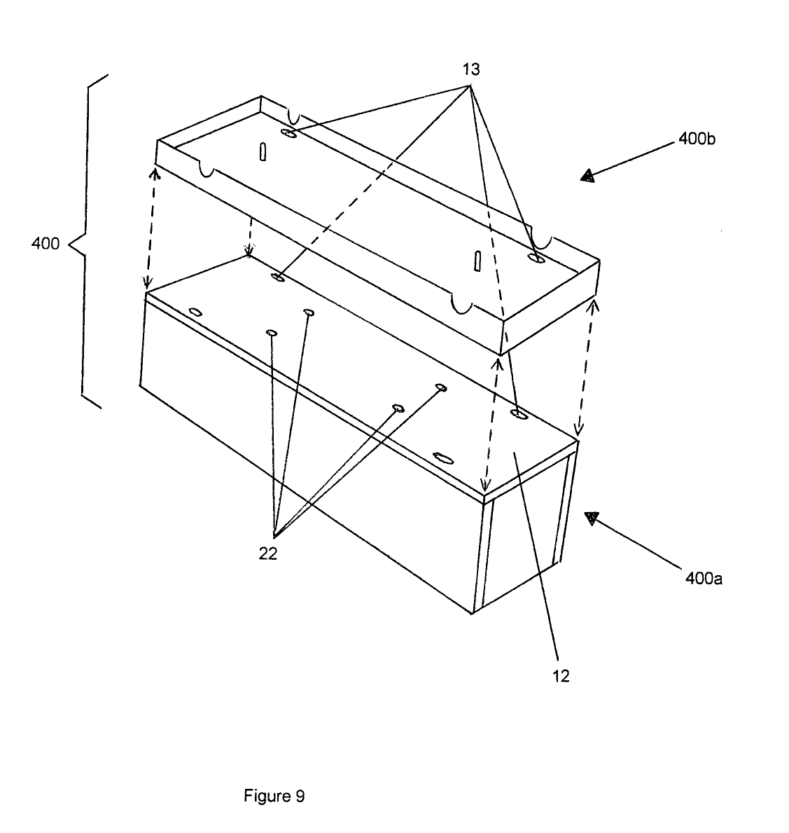

FIG. 9 illustrates an alternate planter receptacle, indicated generally as 400. An underside view is illustrated, wherein an open enclosure similar to that previously described in FIG. 1, and indicated generally as 400a, is shown separate from a drainage reservoir tray, indicated generally as 400b. This underside view shows that open enclosure 400a is designed to align directly above (when right (top)-sided) drainage reservoir tray 400b, including alignment of guides 13 which extend vertically for both 400a and 400b. Drainage reservoir tray 400b further provides a concave upper surface (as in the embodiment of FIG. 10) suitable for receiving water from open enclosure 400a. Suitable holes 22 are provided in horizontal bottom wall 12 to permit such flow.

FIG. 10 illustrates a planter receptacle variation, indicated generally as 800, to show additional features. A top-sided view is illustrated, wherein an open enclosure similar in some respects to that previously described in FIG. 4, and indicated generally as 800a, is shown separate from a drainage reservoir tray, indicated generally as 800b. This top-sided view again shows the alignment capability as described in FIG. 9. Vertical wall 20 extends upwardly from surface 23, and along its perimeter, to provide a drainage reservoir as water is received from open enclosure 800a through holes 22 (illustrated in FIG. 9). FIG. 10 also shows that, as components 800a and 800b are aligned, surface 23 extends outward past side wall 15 of enclosure 800a, allowing water to be poured directly into drainage reservoir tray 800b. This permits up-watering of plants contained in 800a, and improves viewing for determining when the reservoir is full. Water wicks (not illustrated) used in holes 22 (see FIG. 9) enable up-watering which is useful when leafy and dense flowers and plants make watering from the open top of the planter receptacle more difficult. FIG. 10 also shows guides 13a and 13b oriented such that guides 13a are horizontally positioned slightly outward from their vertically associated guides 13b, and guides 13b are contained within blocks 24 to provide for the precise alignment of open enclosure 800a when placed on top of drainage reservoir tray 800b.

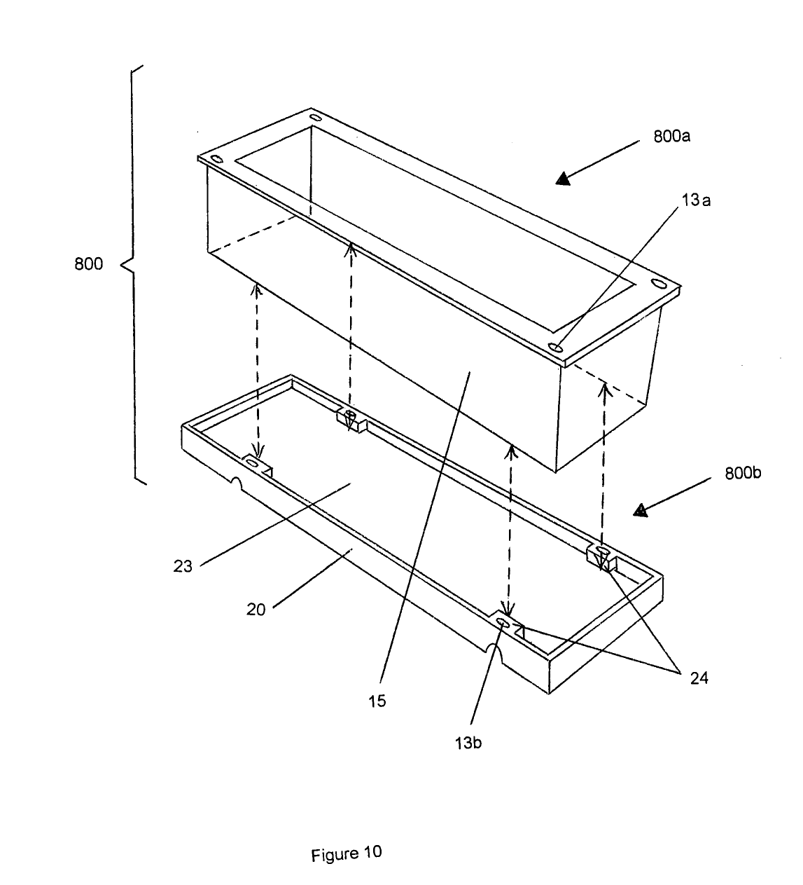

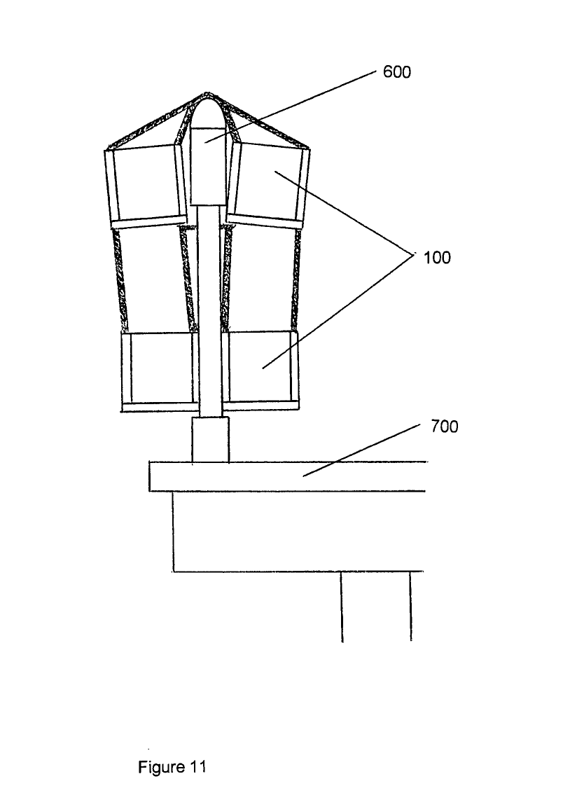

FIG. 11 shows a side perspective view of an installation of multiple planter receptacles 100 on railing 600, attached to deck/balcony 700. Two planter receptacles 100 are shown in a straddle position inside and outside the railing near the railing top. Two additional planter receptacles 100 are shown in a hang-down position immediately below the near top positioned planters, thereby creating a planter array (a multiple planter installation). As an alternate array, the receptacles shown in the hang-down position might be staggered in-between (instead of immediately below) two near top positioned planters (see frontal view in FIG. 12). Numerous other array variations are possible, including on top planter positioning for railings with flat tops. Planter arrays provide more expansive planting accommodations for deck/balcony/porch gardeners, thereby optimizing the use of limited balcony/porch and railing space.

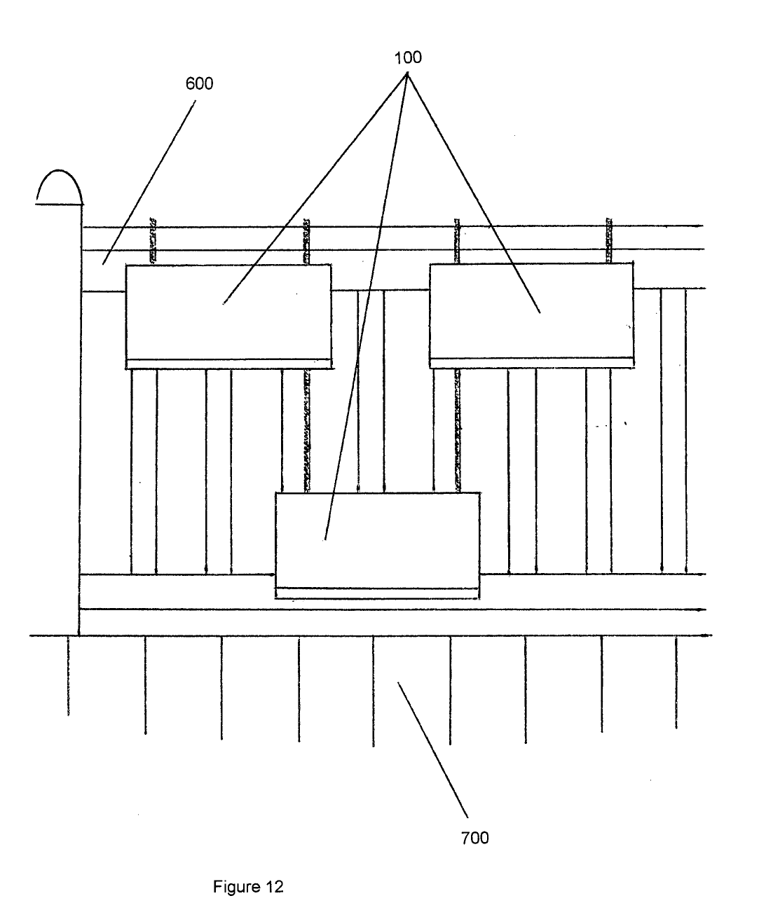

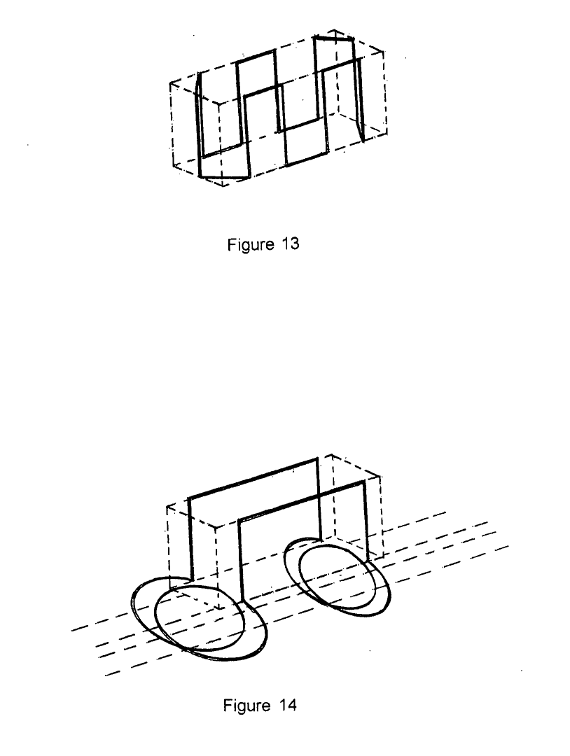

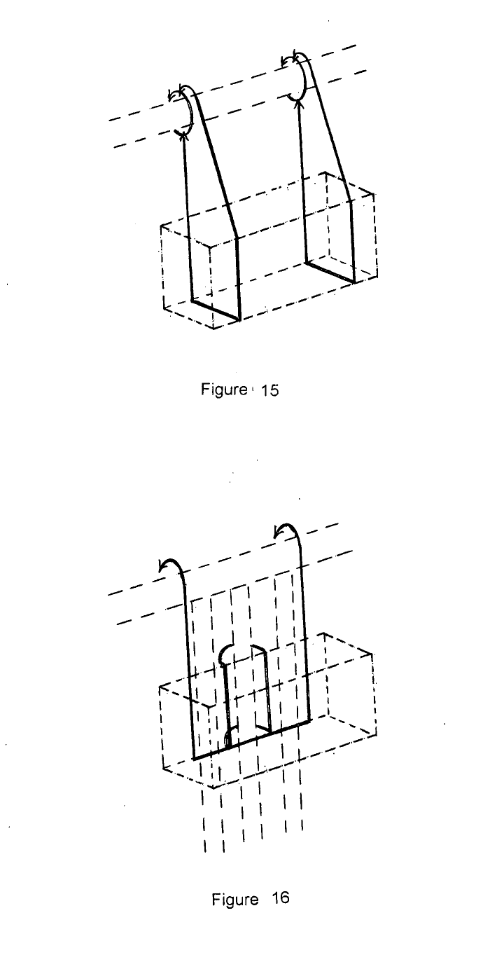

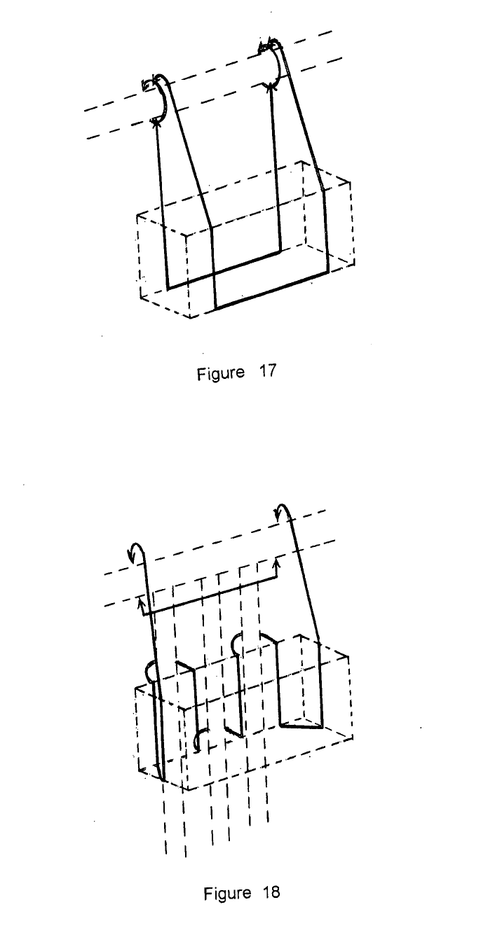

Guides 13, line take-up spool posts 19, and gate-like openings 21 provide for a wide variety of options for positioning a flexible line 500, and thus for hanging one or more planters. Schematic drawings of various lacing techniques are shown in FIGS. 13-18, in which planter 100 (according to any one of the above-described embodiments), and illustrated railing components, are shown in phantom and flexible line 500 is shown as a solid line. More particularly, FIG. 13 shows a planter 100 according to any one of the previously described embodiments in which line 500 is threaded through multiple guides 13 on the side walls of planter 100, including the front and back walls and through a guide on each end wall to enhance the appearance of the exterior of the planter. Whenever a drainage reservoir tray is used, this lacing technique also secures the tray to the open enclosure (upper) receptacle portion of the planter. FIG. 14 shows a top tie-down lacing technique, in which planter 100 is attached to a railing top. It is recommended that in such embodiment, lacing provide for encircling the upper railing two or three times to provide a more stable installation, in addition to being routed through guides 13 on the front and back walls of planter 100. FIG. 15 shows a cradle bottom lacing technique, useful for same side high/low railing installations, in which line 500 is laced through front and back guides and along a bottom surface of planter 100, and is preferably double wrapped around the railing top to reduce lacing slide. This lacing technique provides good leveling capability for the planter from side to side. FIG. 16 shows a cradle back lacing technique, useful for near top of railing installations where little vertical height adjustment is anticipated. This technique is also used for two sided (straddle over) railing installations (again using two planters). As shown in FIG. 16, lacing through multiple guides 13 on the back wall of planter 100 and around a railing baluster may be used to improve leveling and achieve good stability. FIG. 17 shows a cradle back and front lacing technique that provides good planter leveling capability front to back, and is useful whenever vertical height adjustment is less important. Some baluster lacing may also prove helpful for this lacing technique. Last, FIG. 18 shows a side hang lacing technique that provides good vertical height adjustment capability, and provides two vertical suspension lines instead of the four as illustrated in FIGS. 15 and 17. This lacing technique can be used for single planter installations, lower two-sided installations, and for lower planters in a same side high/low installation. It also provides good planter leveling capability from side to side. FIG. 18 shows line 500 laced through multiple guides on the back wall of planter 100, and through guides in each end wall. As illustrated, line 500 may also be laced around one or more railing balusters, and laced around the railing top such that one continuous length of rope may be used for the installation. Because each planter guide, gate, and spool post might accommodate more than one flexible, line, numerous other lacing technique variations are possible, especially when these techniques are used in combination to create planter arrays.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. For instance, while each of the above-described embodiments shows a generally rectangular planter 100, a generally circular, oblong, square, or any other shape could be used without departing from the spirit and scope of the invention. Likewise, while each of the above described embodiments shows solid planter walls, perforated, woven, lined skeletal framing, or another wall type could be used without departing from the spirit and scope of the invention. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

1. A flower planter for mounting on railings and fences, comprising:
a bottom wall;
at least one generally vertical side wall having a top edge and a bottom edge; and
a plurality of generally vertical guides associated with said at least one generally vertical side wall, each said guide having a top opening and a bottom opening, each said guide forming an open channel through which a flexible line may extend and slidably engage said guide.

2. The flower planter of claim 1, wherein said open channel extends through said side wall from said top edge to said bottom edge.

3. The flower planter of claim 1, said top edge having a top outer perimeter that extends horizontally outward from said side wall to define a top ledge, and said bottom edge having a bottom outer perimeter that extends horizontally outward from said side wall to define a bottom ledge, and wherein said open channel extends through both said top ledge and said bottom ledge.

4. The flower planter of claim 1, further comprising at least one post extending outward from at least one of said side wall and said bottom wall.

5. The flower planter of claim 1, further comprising a supportive lip extending vertically downward beyond said bottom edge, said supportive lip being configured to hold said bottom wall above a surface on which the flower planter is positioned.

6. The flower planter of claim 5, further comprising a plurality of lip openings extending through said supportive lip so as to allow a flexible line to pass through said lip without affecting the stability of the flower planter on a surface on which the flower planter is positioned.

7. The flower planter of claim 6, further comprising at least one post extending outward from at least one of said side wall and said bottom wall.

8. The flower planter of claim 5, further comprising at least one post extending outward from at least one of said side wall and said bottom wall.

9. The flower planter of claim 1, wherein said guides are positioned such that a flexible line extending through a first one of said guides and straight to a second one of said guides will traverse at least a portion of said bottom wall so as to vertically support at least a portion of said bottom wall.

10. The flower planter of claim 1, wherein said bottom wall is separable from said side wall.

11. The flower planter of claim 10, said bottom wall further comprising a tray, and said at least one generally vertical side wall forming an open enclosure having an open top and a base which is surrounded by said bottom edge of each said side wall.

12. The flower planter of claim 11, said top edge having a top outer perimeter that extends horizontally outward from said side wall to define a top ledge, and said tray having an outer perimeter positioned horizontally outward from said side wall to define a bottom ledge, and wherein said open channel extends through both said top ledge and said bottom ledge.

13. The flower planter of claim 12, further comprising at least one post extending outward from at least one of said side wall and said bottom wall.

14. The flower planter of claim 12, said tray further comprising a tray base and a supportive lip extending vertically downward beyond said tray base, said supportive lip being configured to hold said tray base above a surface on which the flower planter is positioned.

15. The flower planter of claim 14, further comprising a plurality of lip openings extending through said supportive lip so as to allow a flexible line to pass through said lip without affecting the stability of the flower planter on a surface on which the flower planter is positioned.

16. The flower planter of claim 15, further comprising at least one post extending outward from at least one of said side wall and a bottom surface of said tray base.

17. The flower planter of claim 14, further comprising at least one post extending outward from at least one of said side wall and a bottom surface of said tray base.

18. The flower planter of claim 10, wherein said guides are positioned such that a flexible line extending through a first one of said guides and straight to a second one of said guides will traverse at least a portion of said bottom wall so as to vertically support at least a portion of said bottom wall.

19. A flower planter for mounting on railings and fences, comprising:
a bottom wall;
at least one generally vertical side wall having a top edge and a bottom edge;
a plurality of generally vertical guides associated with said at least one generally vertical side wall, each said guide having a top opening and a bottom opening, each said guide forming an open channel; and
a flexible line extending through a plurality of said generally vertical guides and slidably engaging said guides so as to allow a position of said flower planter with respect to said flexible line to be modified.

20. The flower planter of claim 19, wherein said flexible line further comprises at least two free ends configured for attachment to at least one of a railing and a fence.

21. The flower planter of claim 19, said top edge having a top outer perimeter that extends horizontally outward from said side wall to define a top ledge, and said bottom edge having a bottom outer perimeter that extends horizontally outward from said side wall to define a bottom ledge, and wherein said open channel extends through both said top ledge and said bottom ledge.

22. The flower planter of claim 19, further comprising at least one post extending outward from at least one of said side wall and said bottom wall.

23. The flower planter of claim 19, further comprising a supportive lip extending vertically downward beyond said bottom edge, said supportive lip being configured to hold said bottom wall above a surface on which the flower planter is positioned.

24. The flower planter of claim 23, further comprising a plurality of lip openings extending through said supportive lip so as to allow said flexible line to pass through said lip without affecting the stability of the flower planter on a surface on which the flower planter is positioned.

25. The flower planter of claim 23, further comprising at least one post extending outward from at least one of said side wall and said bottom wall.
